(19) United States
(12) Patent Application Publication
(10) Pub. No.: US 2026/0189010 A1
(43) Pub. Date: Jul. 2, 2026

(54) TRANSFORMER PRECHARGE COORDINATION IN HOME ENERGY SYSTEMS

(71) Applicant: FORD GLOBAL TECHNOLOGIES, LLC, Dearborn, MI (US)

(72) Inventors: Haider Mhiesan, Canton, MI (US); Timothy Harris, Grosse Ile, MI (US); Kirk Pulay, Belleville, MI (US); Christopher Bernard Trombetta, Commerce Township, MI (US)

(21) Appl. No.: 19/290,515

(22) Filed: Aug. 5, 2025

Related U.S. Application Data
(60) Provisional application No. 63/739,980, filed on Dec. 30, 2024.

(51) Int. Cl. H02J 3/32; H02J 3/00; H02J 3/38; H02J 9/06

(52) U.S. Cl. CPC H02J 3/322; H02J 3/0012; H02J 3/388; H02J 9/062; H02J 2105/12

(57) ABSTRACT

A combiner box for a home energy system includes a housing containing a neutral-forming transformer (NFT), a current-limiting element electrically coupled to the NFT, and a precharge switch configured to selectively couple the current-limiting element to the NFT. The housing further includes an NFT switch configured to selectively couple a power source to the NFT in parallel with the current-limiting element. The housing further includes a controller configured to, with the NFT switch open, operate the precharge switch to initiate delivery of current to the NFT through the current-limiting element. The controller is further configured to, after a predefined interval, open the precharge switch and operate the NFT switch to bypass the current-limiting element.

### CROSS-REFERENCE TO RELATED APPLICATION

This application claims the benefit of U.S. provisional application Ser. No. 63/739,980, filed Dec. 30, 2024, the disclosure of which is hereby incorporated in its entirety by reference herein.

### TECHNICAL FIELD

This disclosure relates to power management.

### BACKGROUND

A local energy source may provide electrical power to a building or connected loads independently of utility grid availability.

### SUMMARY

A combiner box for a home energy system includes housing containing a neutral-forming transformer (NFT), a current-limiting element electrically coupled to the NFT, and a precharge switch configured to selectively couple the current-limiting element to the NFT. The housing further includes an NFT switch configured to selectively couple a power source to the NFT in parallel with the current-limiting element. The housing further includes a controller that is configured to, with the NFT switch open, operate the precharge switch to initiate delivery of current to the NFT through the current-limiting element. The controller is further configured to, after a predefined interval, open the precharge switch and operate the NFT switch to bypass the current-limiting element.

An energy system includes electric vehicle supply equipment (EVSE) configured to be electrically coupled to a traction battery of an electric vehicle and, when electrically coupled, to deliver power received from the traction battery. The energy system further includes a home energy management system (HEMS) electrically coupled to the EVSE to receive power from the EVSE. The HEMS includes a transformer configured to establish a local neutral reference, and a current-limiting circuit electrically coupled to the transformer. The HEMS further includes a precharge switch operable to route current through the current-limiting circuit, and a bypass switch configured to selectively couple power received from the EVSE to the transformer in parallel with the current-limiting circuit. The HEMS further includes control logic configured to, with the bypass switch open, actuate the precharge switch to deliver current through the current-limiting circuit, and after current delivery through the current-limiting circuit, deactivate the precharge switch and actuate the bypass switch to bypass the current-limiting circuit.

A method of operating an energy system includes, with a transformer electrically coupled to a power source via a current-limiting circuit and a precharge switch, actuating the precharge switch to initiate current delivery to the transformer through the current-limiting circuit. The method further includes, after an energization interval following actuating the precharge switch, deactivating the precharge switch and activating a bypass switch arranged in parallel with the current-limiting circuit to couple the transformer to the power source.

### BRIEF DESCRIPTION OF THE DRAWINGS

FIG. 1 is a schematic diagram of a home energy system including a neutral-forming transformer and a dual-resistor precharge arrangement.

FIG. 2 is a schematic diagram of an alternative home energy system including a single-resistor precharge arrangement.

FIG. 3 is a flowchart illustrating a method of operating a home energy system with staged transformer activation.

FIG. 4 is a waveform diagram comparing transformer inrush current with and without a precharge sequence.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

A home energy system may include a variety of energy-related components that operate together to supply electrical power to a residence. These components may include a utility grid connection, one or more locally installed power sources such as photovoltaic (PV) panels, a generator, a stationary battery, or a vehicle energy source, and one or more load centers or service panels that distribute power to appliances, lighting circuits, and other domestic loads. The system may further include power converters, relays, switching elements, measurement circuits, and energy management components to coordinate the exchange of electrical energy between sources and loads. In some implementations, the system includes an electric vehicle (EV) and associated electric vehicle supply equipment (EVSE), allowing a traction battery of the EV to be charged from home energy sources or to supply energy to the home in a bidirectional configuration.

To facilitate intelligent coordination of these components, the system may include a Home Energy Management System (HEMS). The HEMS may operate as a centralized or distributed controller that monitors grid status, power flows, system voltage, and device activity to manage energy usage and availability. In addition to supporting normal operation, the HEMS may execute programmed responses to abnormal conditions such as grid outages or faults. These responses may include isolating loads, activating standby power sources, transitioning devices between operational states, or initiating shutdown procedures for specific components.

During grid-connected operation, electrical energy may be delivered to the home from a utility power source via an incoming service line. This energy may be routed through a main service panel or other distribution equipment to power various household loads. Local energy sources—such as solar photovoltaic systems, a generator, or a bidirectionally capable vehicle energy system—may also be connected within the home energy system. These sources may contribute energy to the home or export energy back to the grid, depending on system configuration and operating conditions. In many implementations, these sources are configured to operate in parallel with the grid and may synchronize to grid voltage and frequency when active. A supervisory control component, such as a home energy management system, may monitor grid status, energy consumption, and the availability of local sources in order to determine how best to utilize available energy. Under normal conditions, the control system may prioritize the use of grid power while selectively engaging local sources based on demand, pricing signals, or other control criteria. Components designed to operate during outage or backup scenarios may remain unpowered or in standby during this grid-connected mode.

When the utility grid becomes unavailable, the home energy system may enter a grid-loss or off-grid operating mode. In this state, grid-synchronized devices may cease operation, and the system may rely on local energy sources to maintain functionality. Depending on the implementation, the control system may detect the loss of grid voltage and initiate logic configured to assess which local sources are capable of continuing to provide power under off-grid conditions. Some sources, such as traditional grid-following photovoltaic inverters, may disconnect automatically in response to grid loss, while others—such as standby generators, grid-forming inverters, or appropriately configured energy storage systems—may continue to operate or may be activated by the control system. During grid-loss conditions, certain subsystems that remain inactive during grid-connected operation may become active to support autonomous operation and facilitate coordination of remaining energy assets. These may include control strategies for staged reconnection of power components or sequencing logic to mitigate potentially disruptive startup events.

Electric vehicles (EVs) are increasingly integrated into home energy systems as both energy consumers and potential energy providers. In a typical residential setting, an EV may be connected to the home through electric vehicle supply equipment (EVSE), which serves to transfer electrical energy from the home to the vehicle for charging the onboard traction battery. As battery capacities increase and bidirectional charging technology becomes more prevalent, EVs are being positioned not only as mobile loads but also as distributed energy resources capable of supplying power back to the home under certain conditions. This dual-role functionality allows an EV to operate as a flexible energy node within the broader home energy ecosystem.

In certain implementations, the EV and EVSE are configured to support vehicle-to-home (V2H) operation, in which electrical energy stored in the vehicle's traction battery is supplied to the residence. V2H functionality may be implemented as a subset of vehicle-to-grid (V2G) technology, with the distinction that energy is directed locally to serve household loads rather than being exported to the utility grid. During a V2H operating mode, the EV operates as a backup or supplemental power source, discharging stored energy to support appliances, lighting circuits, or other domestic loads. This energy transfer may occur automatically in response to a grid outage or in accordance with programmed control logic within the home energy system.

Bidirectional energy flow between the EV and the home may be supported by an inverter that converts DC power from the vehicle's traction battery into AC power suitable for household consumption. Depending on system architecture, this inverter may be located onboard the vehicle or integrated within the EVSE. In configurations with an onboard inverter, the EV outputs AC power directly to the home through the EVSE. In other implementations, the EV supplies DC power to the EVSE, which includes an inverter to produce AC output. In either case, the inverter may be configured to synchronize to grid voltage and frequency during grid-connected operation, and may be further capable of operating as a grid-forming source during grid outages to support standalone or backup operation.

During grid-connected operation, the EV typically functions as a load, drawing power through the EVSE to charge its traction battery from the utility grid or local energy sources. In this mode, vehicle-to-home functionality may remain disabled or inactive. When a grid outage is detected, the home energy system may initiate a transition to an off-grid or backup mode in which the EV acts as a local power source. This transition may involve activation of inverter functionality, electrical isolation from the grid, and coordinated engagement of downstream components such as transfer switches, load panels, or transformer windings. In some configurations, the EV inverter may operate in a grid-forming mode to establish voltage and frequency references for the home, enabling continued operation of critical loads during the outage period.

When operating in a vehicle-to-home mode, the home energy system may coordinate power delivery from the EV in accordance with predefined logic. This coordination may include enabling the inverter output, managing connection paths to household loads, and determining the appropriate timing and sequence for engaging various electrical components. To maintain stable operation, the system may reference voltage and frequency thresholds, load demands, or state-of-charge levels. The control approach may also account for conditions in which certain devices are initially unpowered or present high impedance at startup. In such cases, the sequence of engagement may include intermediary steps—such as staged energization or current-limiting techniques—to establish compatible operating conditions before connecting additional loads or devices.

The configuration of a home energy system incorporating vehicle-to-home functionality may vary depending on where power conversion and coordination functions are implemented. In some systems, inverter control and sequencing logic may reside within the EV itself. In others, these functions may be performed by the EVSE, or by a separate supervisory controller such as a home energy management system (HEMS). Regardless of implementation, the ability to control when and how power is delivered from the vehicle to the residence may involve coordinated operation of multiple devices, including relays, sensors, switching components, and programmable control logic. This coordination may be particularly relevant during initial activation of the vehicle as a power source, when certain downstream components—such as transformers or inductive devices—may require special handling to establish proper voltage conditions and manage current levels during engagement.

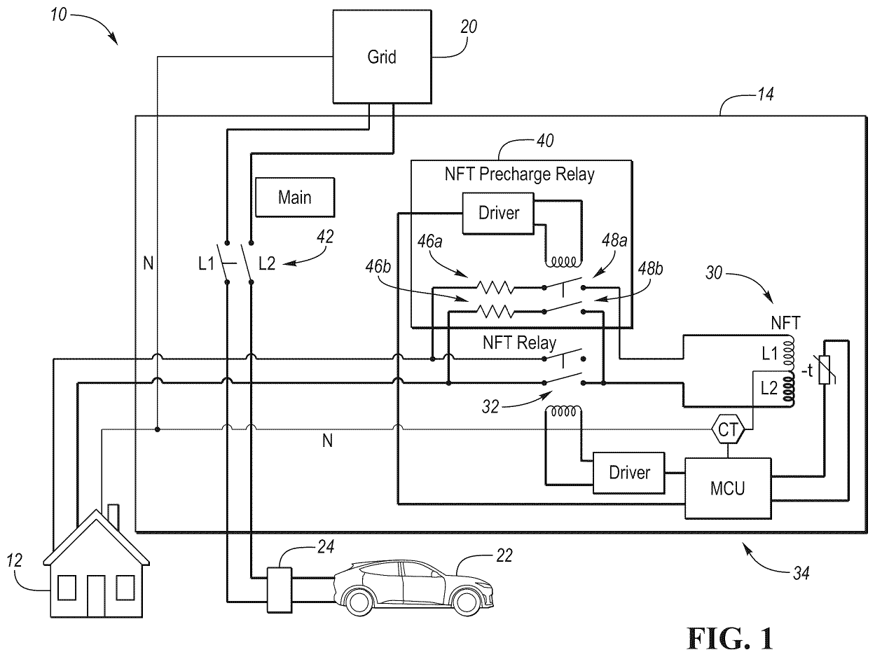

Referring now to FIG. 1, a home energy system 10 includes a residence or building structure 12 served by a power interface such as a Home Energy Management System (HEMS) 14. The HEMS 14—also referred to as a “HEMS hub” or “combiner box” acts as an integration and coordination point for external and local energy resources. In the example shown, the HEMS 14 is electrically connected to an external power grid 20 and to an electric vehicle (EV) 22 via associated electric vehicle supply equipment (EVSE) 24.

The HEMS 14 is configured to coordinate energy flow between the connected components. In the illustrated implementation, the HEMS 14 includes electrical coupling paths to the EVSE 24, the external grid 20, and one or more downstream electrical panels, outlets, or load centers within the residence 12. The HEMS 14 may include relays, current sensors, voltage sensing circuitry, and control electronics to determine when and how each connected source or load is engaged.

The HEMS 14 may further include one or more connections to passive components, such as a neutral-forming transformer (NFT), or to other power-handling elements configured to support voltage shaping, load balancing, or power distribution within the home. In some configurations, the HEMS 14 adjusts these connections to promote appropriate voltage conditions before downstream devices are energized, particularly when transitioning from a standby or unpowered state to an active energy delivery state.

The electric vehicle (EV) 22 includes an energy storage system in the form of a traction battery that stores and supplies electrical energy for vehicle propulsion and other auxiliary functions. The traction battery may include one or more battery modules connected in series or parallel, and may be coupled to an onboard battery management system (BMS) for monitoring voltage, current, temperature, and state-of-charge. In some configurations, the EV 22 further includes an onboard inverter to convert direct current (DC) from the traction battery into alternating current (AC) suitable for driving a motor or supplying power to external loads. Additional vehicle subsystems may include charging interfaces, communication circuits, and control logic for coordinating with external infrastructure, such as charging stations or home energy systems.

The EV 22 is electrically coupled to the home energy system 10 via electric vehicle supply equipment (EVSE) 24. The EVSE 24 provides a conductive interface between the vehicle 22 and the residence 12, facilitating the transfer of electrical energy in one or both directions depending on system configuration. In unidirectional modes, the EVSE 24 enables charging of the traction battery from a grid 20 or local source. In bidirectional implementations, the EVSE 24 also permits energy stored in the traction battery to flow from the vehicle 22 to the home 12, enabling support for vehicle-to-home (V2H) or vehicle-to-building (V2B) operation. The EVSE 24 may include contactors, power electronics, communication interfaces, and control circuitry, and may be coupled to the home 12 through the HEMS 14, which governs when and how energy exchange occurs between the EV 22 and other system components.

During normal grid-connected operation, the HEMS 14 may monitor voltage levels, frequency, and current flow on the connection to the external power grid 20. A disruption or absence of expected voltage conditions on this interface may be interpreted by the HEMS 14 as an indication of a grid outage. In some implementations, voltage monitoring is performed using sensing circuitry integrated within the HEMS 14, while in other implementations, remote devices such as the EVSE 24 or a smart meter may contribute to outage detection. Once a grid outage is identified, the HEMS 14 may initiate a transition to an off-grid operating mode by executing preprogrammed control logic or predefined response sequences.

In response to a detected grid outage, the HEMS 14 may isolate the residence 12 from the external grid 20 by opening one or more electrical relays or contactors 30 positioned along the grid connection path. This isolation helps establish a local energy environment in which power can be delivered from internal sources without interacting with external utility infrastructure. The HEMS 14 may also assess the availability and readiness of internal energy sources, such as the EV 22 or other distributed assets, to determine whether local power generation can support household loads. If local energy is available, the HEMS 14 may begin staging components in preparation for independent operation, including precharging passive devices, energizing voltage-forming inverters, and configuring connection paths to active loads.

Once the HEMS 14 has established the appropriate conditions for off-grid operation, it may activate a control sequence to enable energy delivery from the EV 22 to the home. This may involve sending a signal to the EVSE 24 or the EV 22 itself to initiate inverter activation or DC output. If the inverter is located onboard the EV 22, the EVSE 24 may serve primarily as a conduit for AC power; if the inverter resides within the EVSE 24, the vehicle 22 may supply DC power for conversion. In either case, electrical energy flows from the traction battery of the EV 22 through the EVSE 24 to the HEMS 14, where it is distributed to household circuits or routed through intermediate components such as transformers or power converters. The timing, routing, and engagement of this energy flow may be governed by the HEMS 14 in accordance with internal logic and measured system conditions.

The HEMS 14 may be coupled to one or more passive components positioned between the energy source and the residence 12. These components may include inductive devices, such as transformers, or other load-handling elements that do not actively control or modify current or voltage during startup. When initially energized, such components may present low impedance pathways that draw elevated levels of current, potentially affecting system startup behavior. The HEMS 14 may be configured to manage the initial application of power to these components in a staged or conditioned manner to establish compatible voltage conditions before full engagement.

To manage selective engagement of system components, the HEMS 14 may include one or more relays or switching devices that control current flow along designated electrical paths. These relays may include a primary or main relay responsible for establishing a direct connection between the energy source (e.g., EV 22) and downstream components, as well as one or more secondary relays that enable alternate pathways for staged energization. In certain implementations, a dedicated precharge relay is included in parallel with the main relay and is associated with a current-limiting element such as a resistor. This arrangement allows current to flow in a restricted manner during an initial activation phase, permitting passive components to become energized gradually before full current is applied.

More particularly, the home energy system 10 may include a neutral-forming transformer (NFT) 30 electrically coupled between the HEMS 14 and downstream electrical loads within the residence 12. The NFT 30 may be configured to provide a neutral reference point for line-to-neutral loads or to create a split-phase power configuration compatible with standard household appliances. In some implementations, the NFT 30 is used to emulate utility grid characteristics when operating in an islanded mode, enabling the EV 22 or another distributed energy source to serve as a local supply. The NFT 30 may include a toroidal or conventional core transformer having primary and secondary windings, and may be configured to introduce galvanic isolation, impedance balancing, or voltage transformation as needed. During initial power-up, the NFT 30 may present low impedance to the energy source. Preconditioning measures—discussed in greater detail herein—may be implemented to moderate or inhibit the elevated current levels that might otherwise occur as a result of this low-impedance condition.

The HEMS 14 may include a switching device referred to as an NFT relay 32, which governs the connection between the energy source and the NFT 30. The NFT relay 32 may be positioned along the primary winding path of the NFT 30 and is selectively actuated under control of the system logic. During an initial startup sequence, the NFT relay 32 may remain open while preconditioning elements are engaged to allow the NFT 30 to energize in a controlled manner. Once suitable voltage conditions are detected or a predefined time interval has elapsed, the NFT relay 32 may be closed to establish a direct connection between the energy source and the NFT 30, enabling full power flow through the transformer. The NFT relay 32 may operate in coordination with other switching devices—such as a main relay or precharge relay—to facilitate staged system activation.

The home energy system 10 may include a controller 34 that manages operation of the HEMS 14 and its associated components. The controller 34—also referred to as a system controller, HEMS controller, or microcontroller unit (MCU)—may reside within the HEMS 14 or operate as an external supervisory module in communication with HEMS-connected devices. In various implementations, the controller 34 may comprise one or more processors, memory, and interface circuitry for executing control logic, processing sensor inputs, and issuing relay actuation commands. Among its responsibilities, the controller 34 may monitor system voltage conditions, determine the presence or absence of external grid power, and sequence the activation of switching devices such as a precharge relay, main relay, and NFT relay 32. The controller 34 may apply time-based delays, current-sensing thresholds, or other criteria to govern the transition between staged energization phases. Additional functions may include coordinating inverter startup, managing communication with the EV 22 or EVSE 24, and interfacing with user-defined operating preferences or system-level constraints.

As shown in FIG. 1, grid power is supplied to the HEMS 14 via line conductors L1 and L2 and a neutral conductor N. These conductors are connected to a grid interface switch 42 positioned within the HEMS 14, which may be opened to electrically isolate the residence 12 from the external grid 20 during off-grid operation. The EV 22 is connected to the HEMS 14 through EVSE 24, which may deliver either AC power from an onboard inverter or DC power for conversion within the HEMS 14. The conductors associated with the EV connection may follow the same L1, L2, and N topology as the grid path, allowing the EV 22 to serve as an alternate source of split-phase power when grid service is unavailable. In this example, the HEMS 14 includes a switching arrangement that enables power from the EV 22 to energize the NFT 30 and, in turn, supply the home via the same L1 and L2 load-side conductors used in grid-connected operation.

The HEMS 14 includes a precharge arrangement comprising a precharge module 40 that includes two parallel current-limiting resistors 46a and 46b and associated precharge relay contacts 48a and 48b, each configured to restrict current flow through a respective line conductor L1 or L2 during an initial startup phase. The precharge module 40 may include a module housing that contains the resistors 46a and 46b and relay contacts 48a and 48b therein. The precharge module 40 is positioned between the EV 22 and the NFT 30 and is controlled by the MCU 34. During precharge, the relay contacts 48a and 48b are closed, allowing current to flow through resistors 46a and 46b to gradually energize the primary winding of the NFT 30. Once voltage conditions have stabilized or a prescribed delay interval has elapsed, the NFT relay 32 may be closed to bypass the resistors and establish a full-conduction path from the EV 22 to the NFT 30. The secondary winding of the NFT 30 is connected to the residence 12 and supplies line-to-neutral voltage to household loads in accordance with the established L1, L2, and N topology.

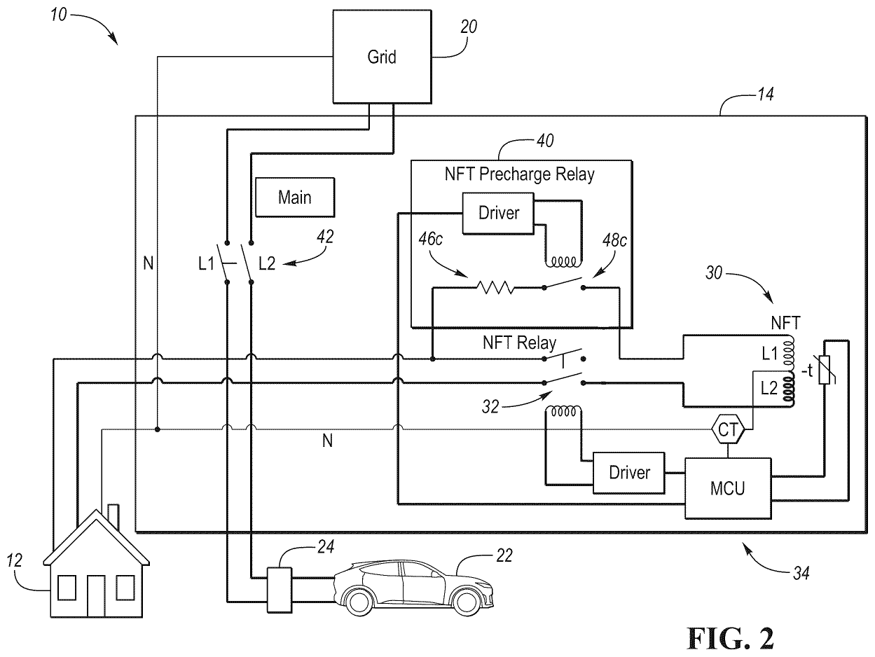

FIG. 2 illustrates an alternative implementation of the home energy system 10 in which the precharge arrangement includes a single current-limiting resistor and relay contact positioned along only one of the two line conductors. In the illustrated example, a single resistor 46c and associated precharge relay contact 48c are placed in series with line conductor L1. This arrangement reduces the number of components needed to implement precharge functionality and may be suitable for systems in which reduced component count, physical space, or wiring simplicity is desired. During precharge operation, current flows through the resistor 46c to energize the NFT 30 in a staged manner. Line conductor L2 in this embodiment may be connected directly to the NFT 30 without current limitation.

In contrast to the dual-path configuration of FIG. 1, which includes independent precharge paths for both L1 and L2, the configuration of FIG. 2 provides a single precharge path via L1. The precharge resistor 46c and relay contact 48c may be controlled by the MCU 34 in the same manner as described above with respect to the dual-path arrangement. Once the precharge interval has elapsed or the energization of the NFT 30 has reached a desired condition, the NFT relay 32 may be closed to complete the full conduction path across both line conductors. Although the FIG. 2 configuration may result in asymmetrical magnetization of the NFT primary during startup, it may nevertheless provide adequate inrush mitigation.

FIG. 3 illustrates an example method 100 for managing activation of a neutral-forming transformer (NFT) 30 in response to a detected loss of grid power. The method is executed by a controller 34 and applies to both the dual-resistor precharge configuration of FIG. 1 and the single-resistor precharge configuration of FIG. 2. In both implementations, the method provides for a staged energization of the NFT 30 to inhibit excessive current levels that may otherwise result from low impedance conditions at initial power-up. The method may be executed automatically upon detection of a grid outage, or in response to a user-initiated or scheduled event.

The controller 34 may include programmed logic or state machine sequencing configured to coordinate the activation of switching elements and monitor one or more system variables. While the sequence of operations remains generally consistent across both configurations, certain implementation-specific behaviors—such as whether current-limiting resistors are applied to both line conductors or to only one—may influence the specific current paths observed during execution. In either case, the method facilitates bringing the NFT 30 online in a controlled manner following grid disconnection, enabling the HEMS 14 to reestablish line-to-neutral voltage for the residence 12 using energy provided by the EV 22.

At step 102 of method 100, the controller 34 monitors electrical conditions associated with the external power grid 20. During grid-connected operation, electrical power is delivered from the grid 20 to the residence 12 via line conductors L1 and L2. The controller 34 evaluates the presence of grid power by sensing voltage or frequency conditions on these input conductors. Upon detecting a loss of expected grid conditions—such as an absence of AC voltage or phase deviation—the controller 34 identifies a grid outage condition and prepares to initiate off-grid operation using an internal energy source, such as the EV 22.

At step 104, the controller 34 initiates isolation of the home energy system 10 from the external grid 20. This may involve opening a grid interface switch 42 positioned within the HEMS 14, thereby electrically disconnecting the residence 12 from utility infrastructure. In some implementations, isolating the grid connection comprises opening one or more grid isolation switches under control of the HEMS controller. This disconnection establishes an islanded operating condition in preparation for localized energy delivery. Grid isolation prevents backfeed and allows the HEMS 14 to operate in an islanded mode using available local energy resources. Once grid isolation is confirmed, the controller 34 proceeds to initiate energization of the neutral-forming transformer (NFT) 30 using a staged precharge approach.

At step 106, the controller 34 activates a precharge circuit to allow limited current flow to the NFT 30. In the embodiment shown in FIG. 1, this involves closing precharge relay contacts 48a and 48b to establish a resistive path through corresponding current-limiting resistors 46a and 46b positioned along line conductors L1 and L2, respectively. In the embodiment shown in FIG. 2, only a single precharge relay contact 48c and resistor 46c are used, positioned along line conductor L1. In either case, the energized precharge path allows the NFT 30 to begin building magnetic flux and voltage across its windings while limiting the magnitude of inrush current that might otherwise result from the NFT's low initial impedance.

In some implementations, the HEMS 14 is configured to coordinate transformer precharging with an electric vehicle 22 acting as a power source via the EVSE 24. Prior to activating the precharge circuit in step 106, the controller 34 may transmit a first command to the electric vehicle—via the EVSE—directing the vehicle's inverter to enter a preparatory mode for voltage ramp-up. This pre-ramp condition allows the vehicle to ready its power electronics while permitting current delivery to begin through the current-limiting path. Following closure of the precharge switch, the controller 34 may transmit a second command instructing the EV to begin ramping its output voltage. The ramp sequence may span a defined number of AC cycles or a specified voltage gradient, and mitigates transient stress on the NFT 30 during initial energization. These steps allow the NFT to begin flux accumulation in a controlled manner while the EV gradually establishes its output waveform, supporting reliable operation in vehicle-to-home or other inverter-driven configurations.

At step 108, the controller 34 maintains the precharge relay(s) in a closed state for a predefined interval. This interval may be determined by a fixed time delay, a measured voltage threshold, or a combination of timing and sensing criteria. For example, the controller 34 may monitor voltage at the input terminals of the NFT 30 to confirm that an expected minimum voltage has developed, indicating partial magnetization of the transformer. Alternatively, a timer may be used to define a duration expected to accommodate inductive charging of the NFT 30. The goal of this interval is to allow the transformer to reach a compatible energization state prior to full current conduction.

In some implementations, the predefined interval during which the precharge switch remains closed is defined by a predetermined time delay. This time delay may be selected to provide sufficient opportunity for the NFT 30 to develop a compatible voltage or flux state while limiting energy loss through the current-limiting element. The time delay may be, for example, between approximately 10 milliseconds and 1 second, and more particularly, between approximately 1 and 5,000 milliseconds (e.g., between approximately 10 and 500 milliseconds). The time delay may vary depending on system characteristics such as transformer size, inverter behavior, and ambient conditions. Other example durations may include a short precharge window between approximately 10 and 100 milliseconds in fast-reacting systems, or a longer delay between approximately 100 milliseconds and 1 second for systems with larger magnetic components or slower ramp profiles. In some configurations, the interval may be fixed; in others, it may be adjusted dynamically based on sensed electrical conditions or user-defined configuration parameters.

In some implementations, the predefined interval is governed by a measured voltage threshold. For example, the controller 34 may monitor voltage at the input terminals of the NFT 30, and determine whether a sufficient energization state has been reached. If the sensed voltage exceeds a threshold—such as 80% of the nominal AC operating level—the controller 34 may transition out of precharge mode by actuating the NFT switch and disabling the precharge path. This voltage-based determination may be used alone or in combination with a time-based threshold to provide flexible control across varied system conditions.

In an implementation involving EV-based power delivery, the energization interval may additionally include a confirmation signal from the electric vehicle 22 indicating completion of its voltage ramp. During this interval, the controller 34 may monitor a status message received from the EV 22—communicated via the EVSE 24—signaling that the output voltage has reached a target amplitude or that a defined number of voltage cycles have been completed. In some cases, the controller 34 may require both the lapse of a minimum time threshold and receipt of the voltage ramp confirmation signal before proceeding to activate the bypass switch. This dual-condition approach enables coordinated interaction between the EV 22 and the HEMS 14 and allows the system to adjust to varying inverter operation or ramp timing profiles.

At step 110, the controller 34 transitions the system from precharge mode to full conduction mode. This involves opening the precharge relay contact(s) 48a and 48b (FIG. 1) or 48c (FIG. 2) to discontinue current flow through the associated resistor(s), and closing the NFT relay 32 to establish a low-impedance conduction path from the EV 22 to the primary winding of the NFT 30. Once this relay is closed, energy from the EV 22 may flow directly into the transformer without current limitation, enabling full energization of the magnetic core and consistent AC voltage transformation. At this point, the precharge circuit is inactive, and the system is configured for steady-state operation.

At step 112, the home energy system 10 is configured for off-grid operation using the electric vehicle 22 as the local power source. With the NFT relay 32 closed and the transformer 30 fully energized, alternating current (AC) power is delivered through the secondary winding of the NFT 30 to supply one or more load circuits within the residence 12. The controller 34 may coordinate additional switching operations to selectively energize load branches based on system conditions, load prioritization, or user-defined preferences. In this configuration, the EV 22 operates as a standalone energy source, delivering power through the EVSE 24, through the HEMS 14, and into the home's distribution system without support from the external utility grid 20.

The method 100 provides a structured sequence for transitioning a home energy system 10 from grid-connected operation to an off-grid state in response to a detected outage. Through active control of relay elements and staged energization of the neutral-forming transformer 30, the controller 34 enables a smooth and reliable startup sequence that mitigates inrush current and supports power delivery from the EV 22 to household loads. By accommodating both dual-path and single-path precharge architectures, the method is adaptable to various system configurations. The sequence promotes compatibility between bidirectional vehicle energy sources and downstream AC distribution systems, enhancing the system's ability to maintain continuity of power during external service disruptions.

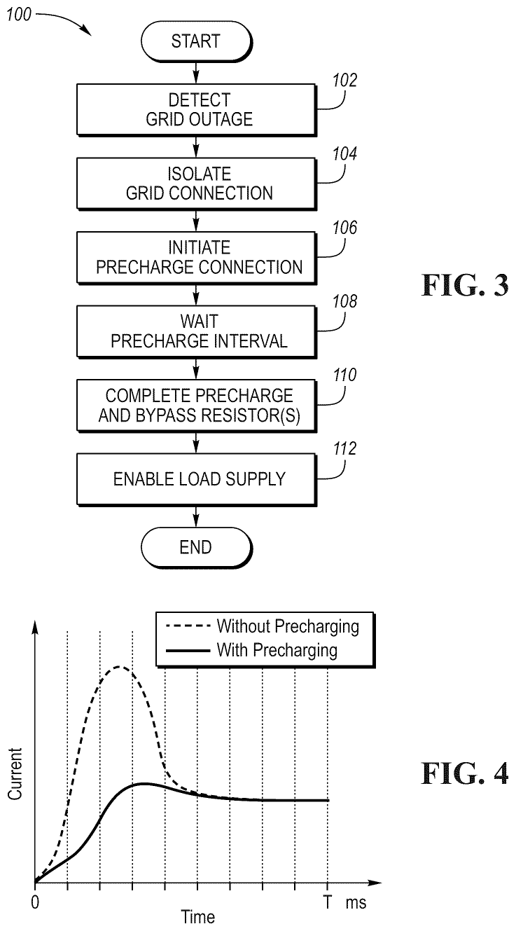

FIG. 4 illustrates current behavior observed during initial energization of the NFT 30. The chart includes two traces representing current entering the primary winding of the NFT 30 as a function of time. The traces reflect current behavior during a brief window of time following grid disconnection and activation of local energy delivery.

The dashed trace in FIG. 4 represents the current entering the NFT 30 when no precharge arrangement is present. At the moment of inverter engagement, the NFT 30 presents a low-impedance load to the inverter output, resulting in a sharp and immediate inrush of current. This behavior is characteristic of transformer energization, during which magnetizing current surges to rapidly establish flux in the transformer core. The waveform exhibits a pronounced peak followed by a decay toward a steady-state current level, as the NFT transitions from an unenergized to a magnetized state. The initial overshoot may place substantial electrical stress on upstream components, including relays and power electronic switches.

The solid trace in FIG. 4 represents the current entering the NFT 30 during a startup sequence that includes activation of the precharge arrangement described above. In this case, the inverter output is initially coupled to the NFT 30 through one or more current-limiting resistors 46a-46c, thereby moderating the rate at which current is delivered to the transformer. This results in a gradual rise in NFT input current, with substantially reduced peak amplitude compared to the no-precharge condition. As the NFT core magnetizes over time, the precharge current increases until a sufficient energization level is achieved. The system then transitions to a full-conduction state by closing the corresponding main relay(s) 44a-44b or NFT relay 48a-48c. Following this transition, the current converges toward the same steady-state level observed in the dashed trace, indicating normal operating conditions have been reached.

As shown in FIG. 4, while the two traces ultimately converge to a common steady-state current level, the transient behavior at startup differs significantly. The precharge arrangement produces a smoother, lower-magnitude current profile during initial energization, in contrast to the sharp inrush observed when no precharge is applied. By reducing the rate of current change and limiting peak amplitude, the precharge configuration decreases electrical stress on the inverter, relays, and transformer windings. The illustrated results may be achieved in either of the system configurations shown in FIGS. 1 and 2, and the underlying method steps may be implemented in accordance with the approach described in FIG. 3.

The waveform behavior depicted in FIG. 4 illustrates the practical benefit of incorporating a precharge mechanism when transitioning to local energy delivery. By moderating the initial current supplied to the NFT 30, the system may more reliably support startup sequences involving inverter-driven power sources, such as an electric vehicle 22 or stationary battery system. This capability may be particularly valuable in off-grid or backup scenarios in which local power is supplied through a vehicle-to-home (V2H) connection or similar interface. Although the figure illustrates one representative example, the specific waveform characteristics may vary depending on system topology, transformer parameters, load conditions, and control timing. In each case, however, the inclusion of a precharge stage allows the NFT 30 to reach an appropriate energized state prior to full-current conduction.

Although the examples above describe an EV 22 as the primary local energy source during grid outage conditions, other configurations are possible. In some implementations, the home energy system 10 may include or be coupled to a stationary battery system or other energy storage resource. This battery may be installed within the residence 12 or integrated into the HEMS 14 and may provide direct current (DC) power that is routed through appropriate conversion stages for delivery to household loads. In such configurations, the precharge strategy described above—incorporating current-limiting resistor(s) and sequencing of relay elements—may be applied to control energization of the neutral-forming transformer 30 when switching from a standby state to active energy delivery.

Other local energy sources may include fuel-powered generators, photovoltaic (PV) systems configured for islanded operation, or hybrid energy systems combining multiple technologies. For example, a battery-backed PV system may provide sufficient voltage and current to energize the NFT 30 after grid loss. The described control logic may be adapted to accommodate differing startup dynamics associated with each source type. In such cases, the controller 34 may adjust source activation, monitor voltage thresholds, and manage sequencing of relay elements to coordinate transformer energization and delivery of power to the residence.

The system 10 may also include logic to prioritize among available energy sources based on predefined criteria such as source capacity, state-of-charge, time-of-day availability, or user preferences. For instance, when both an EV 22 and a stationary battery are present, the controller 34 may select one or the other as the primary source for energizing the NFT 30, or may switch between them based on dynamic system conditions. The described precharge circuit and transformer startup sequence may be reused regardless of which source is selected.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A combiner box for a home energy system, comprising:
a housing containing a neutral-forming transformer (NFT), a current-limiting element electrically coupled to the NFT, a precharge switch configured to selectively couple the current-limiting element to the NFT, an NFT switch configured to selectively couple a power source to the NFT in parallel with the current-limiting element, and a controller programmed to, with the NFT switch open, operate the precharge switch to initiate delivery of current to the NFT through the current-limiting element, and after an interval, open the precharge switch and operate the NFT switch to bypass the current-limiting element.

2. The combiner box of claim 1, wherein the current-limiting element comprises a pair of resistors, and wherein the precharge switch comprises a pair of switch contacts respectively associated with each resistor.

3. The combiner box of claim 1, wherein the current-limiting element comprises a single resistor electrically coupled to a single line conductor of a split-phase power connection.

4. The combiner box of claim 1, wherein the interval comprises a time delay in a range of 10 milliseconds to 5,000 milliseconds.

5. The combiner box of claim 1, wherein the power source comprises an inverter output of a vehicle energy system.

6. The combiner box of claim 1, wherein the controller is configured to operate the precharge switch after detecting isolation from a utility grid.

7. The combiner box of claim 1, wherein the controller is configured to sense current entering the NFT and terminate the interval based on a current threshold.

8. The combiner box of claim 1, wherein the housing further contains a precharge module that includes the current-limiting element and the precharge switch, and wherein the precharge module is configured to limit current flow to the NFT when the NFT switch is open.

9. An apparatus comprising:
a home energy management system, configured to be electrically coupled to electric vehicle supply equipment (EVSE), including a transformer configured to establish a local neutral reference, a current-limiting circuit electrically coupled to the transformer, a precharge switch operable to route current through the current-limiting circuit, a bypass switch configured to selectively couple power received from the EVSE to the transformer in parallel with the current-limiting circuit, and control logic configured to, with the bypass switch open, actuate the precharge switch to deliver current through the current-limiting circuit.

10. The apparatus of claim 9, wherein the control logic is configured to, after current delivery through the current-limiting circuit, deactivate the precharge switch and actuate the bypass switch to bypass the current-limiting circuit.

11. The apparatus of claim 10, wherein the transformer is a neutral-forming transformer configured to support an operation mode using power received from a traction battery via the EVSE.

12. The apparatus of claim 10, wherein the control logic is configured to detect availability of a traction battery as a power source via the EVSE prior to initiating precharge.

13. The apparatus of claim 10, wherein the home energy management system includes a measurement circuit configured to sense current flow from the EVSE during energization of the transformer.

14. A method of operating an energy system, comprising:
with a transformer electrically coupled to a power source via a current-limiting circuit and a precharge switch, actuating the precharge switch to initiate current delivery to the transformer through the current-limiting circuit; and
after actuating the precharge switch, deactivating the precharge switch and activating a bypass switch arranged in parallel with the current-limiting circuit to couple the transformer to the power source.

15. The method of claim 14, wherein the power source is a traction battery of an electric vehicle, the method further comprising receiving power from the traction battery via electric vehicle supply equipment (EVSE).

16. The method of claim 14, further comprising transmitting a command to an electric vehicle via electric vehicle supply equipment (EVSE) to initiate a voltage ramp-up of the power source.

17. The method of claim 16, wherein actuating the bypass switch is performed after receiving a confirmation signal from the electric vehicle indicating completion of the voltage ramp.

18. The method of claim 14, wherein the current-limiting circuit comprises a pair of resistors arranged on respective conductors that supply current to the transformer.

19. The method of claim 14, wherein the current-limiting circuit comprises a single resistor arranged on one conductor that supplies current to the transformer.

20. The method of claim 14, further comprising detecting an islanding condition following a loss of grid voltage and initiating actuating the precharge switch in response to the islanding condition.
